(19) United States
(12) Patent Application Publication
(10) Pub. No.: US 2006/0000737 A1
(43) Pub. Date: Jan. 5, 2006

(54) Marketing and selling athletic apparel based upon performance characteristics

(76) Inventor: Lorrie Gabrielle Vogel, Lake Oswego, OR (US)

Correspondence Address: BANNER & WITCOFF, LTD., 1001 G STREET, N.W., WASHINGTON, DC, 20001-4597, US

(21) Appl. No.: 11/009,605

(22) Filed: Dec. 10, 2004

Related U.S. Application Data
(60) Provisional application No. 60/529,524, filed on Dec. 15, 2003.

(51) Int. Cl. B65D 85/00; B65D 85/18; G09F 3/00; A47F 7/08

(52) U.S. Cl. 206/459.5; 206/278; 40/312; 211/35; 211/85.3

(57) ABSTRACT

Techniques are described for marketing and purveying athletic apparel based upon performance characteristics. The performance characteristics may be, for example, shown on display area of a container or other packaging for the athletic apparel. Still further, the performance characteristics may be shown on a product display associated with the athletic apparel. In addition to the performance characteristics for a particular piece of apparel, a product display or display area of a piece of apparel may also show alternate performance characteristics associated with a model of the piece of apparel.

This application claims priority to provisional U.S. Application No. 60/529,524, filed Dec. 15, 2003, entitled “Marketing And Selling Athletic Apparel Based Upon Performance Characteristics” and naming Lorrie Vogel as inventor, which provisional patent application is incorporated entirely herein by reference.

### FIELD OF THE INVENTION

The present invention relates to the marketing and sales of athletic apparel. Various aspects of the present invention are particularly applicable to the marketing and sales of athletic footwear.

### BACKGROUND OF THE INVENTION

The modern consumer of athletic apparel is faced with a variety of choices and selections that have not previously been available. For example, a consumer 50 years ago might only have been able to purchase one type of simple, canvas athletic shoe, such as the type made by Converse, Inc. Today, however, even a single vendor in a medium-sized metropolitan area might sell over fifteen different types of shoes specifically designed for running. If a consumer has access to multiple vendors with shoes from previous fashion seasons, he or she may be select from among hundreds of shoes specially designed for a specific purpose, such as off-road running or track running.

This wide variety of choices should benefit most consumers of athletic apparel. That is, every consumer should be able to obtain athletic apparel having a combination of performance characteristics suitably tailored for the consumer's needs. Thus, a runner who overpronates should be able to obtain a shoe that provides enhanced stability. A heavyset runner or a runner with high-impact strides likewise should be able to obtain shoes that have extra cushioning, to protect the runner's joints from shock. In practice, however, this wide variety of choices in athletic apparel simply confuses, rather than benefits, most consumers. Most pieces of athletic apparel do not provide a consumer with information regarding its performance characteristics. For example, footwear may indicate size information, such as width, but it does not typically indicate how much cushioning it has, or how much stability it provides. Thus, while a consumer theoretically may be able to purchase a piece of athletic apparel that is particularly appropriate for the consumer's needs, the consumer has no way to identify that single piece of apparel from among the variety of possible choices.

Further, even if the apparel manufacturer does provide information regarding the performance characteristics of a piece of apparel, that information typically is anecdotal in nature, and does not quantitively define those performance characteristics. For example, a footwear manufacturer may indicate that a particular model of shoe is intended for use by runners who underpronate, but this generic information does not inform a consumer as to the specific performance characteristics of the shoe. In other circumstances, the apparel may include information generally describing various features of the apparel. For example, an outerwear jacket may be marked as “water resistant,” but that information alone will not indicate how much water the jacket actually can resist before becoming waterlogged. Similarly, athletic footwear may indicate that it has a “high” degree of cushioning, but this information alone will not indicate how much force that the footwear's cushioning can actually absorb.

Often, these types of generalized information will not assist a consumer in choosing one piece of athletic apparel over another, and may even mislead a consumer into using inappropriate apparel. For example, two different models of footwear designed for running may both be identified as having a “high” level of cushioning. Because this use of the term “high” is relative, however, the consumer will not be able to determine which model actually offers more cushioning. The consumer thus will have no way to determine which of the two models will be more beneficial to his or her running style. Instead of using the vague description provided by an apparel manufacturer, the consumer must therefore instead primarily rely upon a brief testing of the apparel at the retail location. This cursory type of testing, however, may not properly inform the consumer as to the performance characteristics of the apparel.

Moreover, even if a consumer is fortunate enough to select athletic apparel that satisfies the consumer's needs, the consumer probably will not be able to repeat the selection later. For example, a consumer may find that a particular model of footwear, labeled as having a “high” degree of cushioning, is particularly suited to the consumer's use of the footwear. When the footwear wears out, the consumer will naturally purchase another pair of the same model. In many cases, however, a manufacturer may change the performance characteristics associated with a model name without changing the description of those performance characteristics. Accordingly, a model of footwear that is described as having a “high” level of cushioning actually may have a different amount of cushioning than a later version of that footwear model that is also a “high” level of cushioning.

### BRIEF SUMMARY OF THE INVENTION

Advantageously, various embodiments of the invention provide techniques for marketing and purveying athletic apparel based upon performance characteristics. The performance characteristics may be, for example, shown on display area of a container or other packaging for the athletic apparel. Still further, the performance characteristics may be shown on a product display associated with the athletic apparel. For example, with various embodiments of the invention, the performance characteristics of a piece of athletic apparel may be shown on a product insert placed into or otherwise attached to a piece of athletic apparel, or a placard positioned close to a piece of athletic apparel at a point of sale or distribution for the apparel. In addition to the performance characteristics for a particular piece of apparel, with various embodiments of the invention the product display or display area of a piece of apparel may also show alternate performance characteristics associated with a model of the piece of apparel.

According to various embodiments of the invention, an index of available performance characteristics will be associated with the athletic apparel. For example, the index may be provided on a product display associated with the athletic apparel, or on the display area of the packaging of the athletic apparel. With various embodiments of the invention, the index may be arranged in a matrix or array that will allow the specific performance characteristics of a particular piece of athletic apparel to be readily identified. According to various embodiments of the invention, each of the available performance characteristics will correspond to specific quantitative values.

### BRIEF DESCRIPTION OF THE DRAWINGS

FIG. 1 illustrates an index of available performance characteristics that may be associated with athletic footwear.

FIGS. 2-4 illustrates examples of a display area showing performance characteristics that may be provided on a container or other packaging of athletic footwear according to various embodiments of the invention.

FIG. 5 illustrates packaging for athletic footwear that provides both a display area showing performance characteristics for the athletic footwear and an index of available performance characteristics.

FIG. 6 illustrates the use of a product display showing available performance characteristics at a point of sale or distribution of athletic footwear.

FIGS. 7 and 8 illustrates product strips showing performance characteristics that may be inserted into or otherwise attached to athletic footwear according to various embodiments of the invention.

FIG. 9 illustrates a product insert showing performance characteristics that may be inserted into or otherwise attached to athletic footwear according to various embodiments of the invention.

FIGS. 10 and 11 illustrate how the product insert illustrated in FIG. 9 may be inserted into an athletic shoe.

FIG. 12 illustrates a placard showing performance characteristics for a variety of different footwear models.

### DETAILED DESCRIPTION OF THE INVENTION

Overview

As will be discussed in more detail below, various embodiments of the invention provide techniques for marketing and purveying athletic apparel based upon the apparel's performance characteristics. The manufacturer or other retailer purveying the athletic apparel may, for example, provide the performance characteristics of a piece of athletic apparel on a display area of its container or other packaging. The performance characteristics may alternately or additionally be shown on a product display associated with the athletic apparel. For example, with various embodiments of the invention, the performance characteristics of a piece of athletic apparel may be shown on a product tag attached to or otherwise associated with a piece of athletic apparel. Further, the performance characteristics of a piece of athletic apparel may be shown on a product insert placed into a piece of athletic apparel.

Alternately or additionally, the manufacturer or other retailer purveying the athletic apparel may provide a placard positioned near the athletic apparel at its point of sale or distribution. In addition to the performance characteristics for a particular piece of apparel, with various embodiments of the invention the product display or display area of a piece of apparel may also show alternate performance characteristics associated with a model of the piece of apparel. For example, if alternate performance characteristics are available for that mode of athletic apparel, then the display area on the packaging for that apparel may show those alternate performance characteristics. In this manner, a consumer will be alerted to the possibility of obtaining that model of athletic apparel with those alternate performance characteristics.

According to various embodiments of the invention, the manufacturer or other retailer purveying the athletic apparel will also may provide an index of available performance characteristics for the athletic apparel. This index may, for example, be provided on a product display associated with the athletic apparel, or on a display area of the packaging of the athletic apparel. The index serves as a key to the different performance characteristics available for the athletic apparel, so that a consumer may be educated as to the various types of athletic apparel available from the manufacturer or retailer. With various embodiments of the invention, the index may be arranged in a matrix or array. This arrangement may allow the specific performance characteristics for a particular piece of athletic apparel shown, e.g., on the packaging display area, to be readily identified.

According to various embodiments of the invention, the available values for each of the performance characteristics will correspond to specific quantitative values. Accordingly, a consumer can be assured that two different models of athletic apparel having the same performance characteristics will, in fact, provide the same performance during use. With some embodiments of the invention, the packaging display area, product insert, product tag or product display may not actually provide the quantitative values corresponding to the performance characteristics. With still other embodiments of the invention, however, one or more of the packaging display area, product insert, product tag or product display may include the quantitative values corresponding to the performance characteristics.

While various embodiments of the invention may be applied to different types of athletic apparel, some embodiments of the invention may be particularly useful for marketing and purveying athletic footwear. Accordingly, specific examples of the invention will be discussed with regard to athletic footwear for ease and convenience of understanding.

Index Of Performance Characteristics

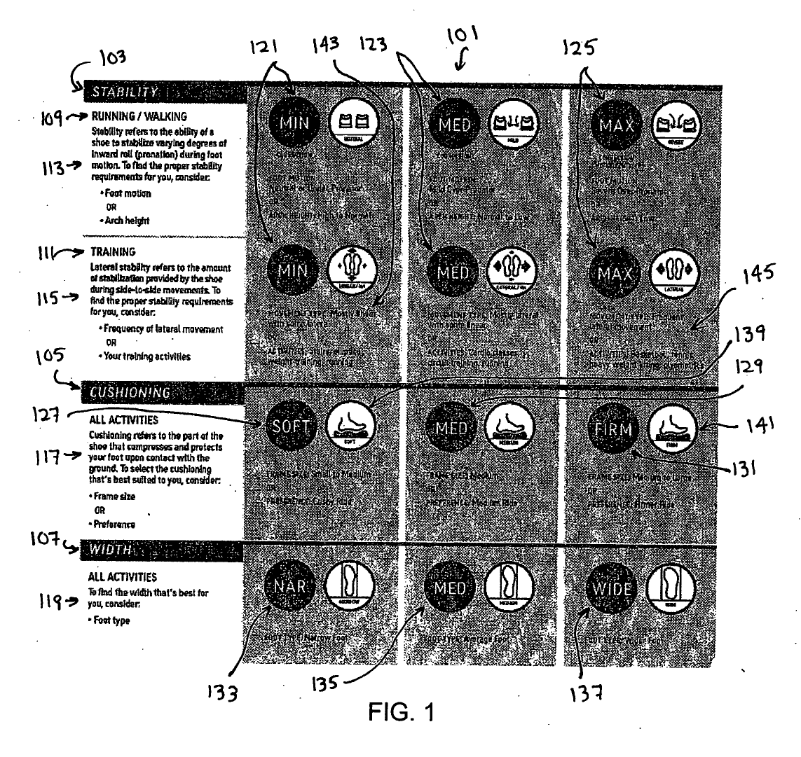

Referring now to FIG. 1, this figure shows an index 101 of the performance characteristics available for athletic footwear. The index 101 lists three performance categories 103-107: a stability performance category 103, a cushioning performance category 105, and a width performance category 107. The stability performance category 103 further includes two sub-categories 109 and 11. More particularly, the stability performance category 103 includes a running/walking stability performance sub-category 109 and a training stability performance sub-category 111.

In the illustrated embodiment, each of the performance categories and subcategories includes material describing the features or use of that category. For example, the running/walking stability performance sub-category 109 has descriptive material 113, explaining that stability refers to the ability of a shoe to stabilize varying degrees of inward roll or “pronation” during foot motion. The descriptive material 113 may alternately or additionally note that “foot motion,” “arch height” or both should be considered when determining the running/walking stability that is best for an individual consumer. Likewise, the training stability performance sub-category 111 has associated descriptive material 115, which may explain, for example, that lateral stability refers to the amount of stabilization provided by a shoe during side-to-side movement. The descriptive material 115 may alternately or additionally explain, for example, that the consumer's “frequency of lateral movement,” “training activities,” or both should be considered when determining the training stability that is best for an individual consumer.

Similarly, descriptive material 117 is provided below the listing of the cushioning performance category 105. The descriptive material 117 may explain, for example, that the cushioning performance values refer to the part of the footwear that compresses and protects the foot upon contact with the ground. The descriptive material 117 may alternately or additionally explain that “frame size” or user “preference” should be considered to determine the cushioning that is best for an individual consumer. Also, descriptive material 119 is provided below the listing of the width performance category 107, explaining that “foot type” should be considered to determine the footwear width that is best for the consumer.

With the index 101 illustrated in FIG. 1, the performance categories and sub-categories are arranged in a single column. As seen in this figure, the available performance characteristics associated with each performance category are then are listed in a row including the performance category. Accordingly, for the row listing the running/walking stability performance sub-category 109, the index 101 may also list a minimum stability performance characteristic 121, a medium stability performance characteristic 123, and a maximum stability performance characteristic 125. Likewise, for the row listing the training stability performance sub-category 111, the index 101 may also list a minimum stability performance characteristic 121, a medium stability performance characteristic 123, and a maximum stability performance characteristic 125. Thus, these listings inform a consumer that both shoes used for running/walking and shoes used for training are available with minimum, medium and maximum stability performance characteristics.

In a similar manner, for the row listing the cushioning performance category 105, the index 101 may also list a soft cushioning performance characteristic 127, a medium cushioning performance characteristic 129, and a firm cushioning performance characteristic 131. This listing informs the consumer that footwear is available with a soft, medium and firm cushioning performance characteristic. For the width performance category 107, the index 101 may list a narrow width performance characteristic 133, a medium width performance characteristic 135, and a wide width performance characteristic 137. The index 101 thus indicates to a consumer that footwear is available with a narrow, medium and wide width performance characteristic.

In addition to listing the performance characteristics for each performance category, the index 101 may list additional information to assist a consumer in understanding the performance characteristics that are available for associated footwear. With some embodiments of the invention, the index 101 may show iconic information corresponding to one or more of the performance characteristics. For example, an icon 139 may be shown next to the display of the soft cushioning performance characteristic 127. The icon 139 may, for example, show a foot significantly deforming a cushion below the foot. Similarly, an icon 141 may be displayed next to the listing of the firm cushioning performance characteristic 131, which shows a foot contacting a cushion without the cushion being substantially deformed.

The index 101 may alternately or additionally include text information corresponding to one or more of the performance characteristics. For example, the index 101 may show descriptive text 143 below the listing of the training minimum stability performance characteristic 121. The descriptive text 143 may, e.g., explain that this degree of cushioning is suitable for mostly linear movement with some lateral movement, or for activities such as stair climbing, using an elliptical machine, weight training or running. Similarly, the index 101 may show descriptive text 145 below the listing of the training maximum stability performance characteristic 125. The descriptive text 145 may explains that this highest level of cushioning is suitable for frequent lateral movement or activities such as basketball, tennis, heavy weight lifting or plyometrics.

Thus, the index 101 displays the performance characteristics in a matrix or array arrangement. As will be discussed in more detail below, consistent arrangement of the available performance characteristics into a matrix or array can be used to assist a consumer in more quickly identifying desired footwear.

While the index 101 includes a matrix of performance characteristics with four performance categories and subcategories and three performance characteristics per category, it should be appreciated that this example is illustrative only. Various embodiments of the invention may include more or fewer performance categories and subcategories. For example, some embodiments of the invention may have only a single stability performance category 103, without dividing this category into subcategories. Alternately, one or more of the categories may be divided into three or more subcategories. For example, with some embodiments of the invention, the cushioning performance category 105 may be divided into a running subcategory, a basketball subcategory, and a tennis subcategory.

Still further, various embodiments of the invention may alternately or additionally provide more or fewer performance characteristics for one or more of the performance categories. Thus, with alternate embodiments of the invention, the cushioning performance category 105 may have four performance characteristics, such as soft cushioning, medium cushioning, firm cushioning and very firm cushioning. Moreover, the values of the performance characteristics may vary from those shown in the index 101. For example, with alternate embodiments of the invention, the available performance characteristics for the cushioning performance category 105 may be low, medium and high rather than soft, medium and firm.

Packaging Display

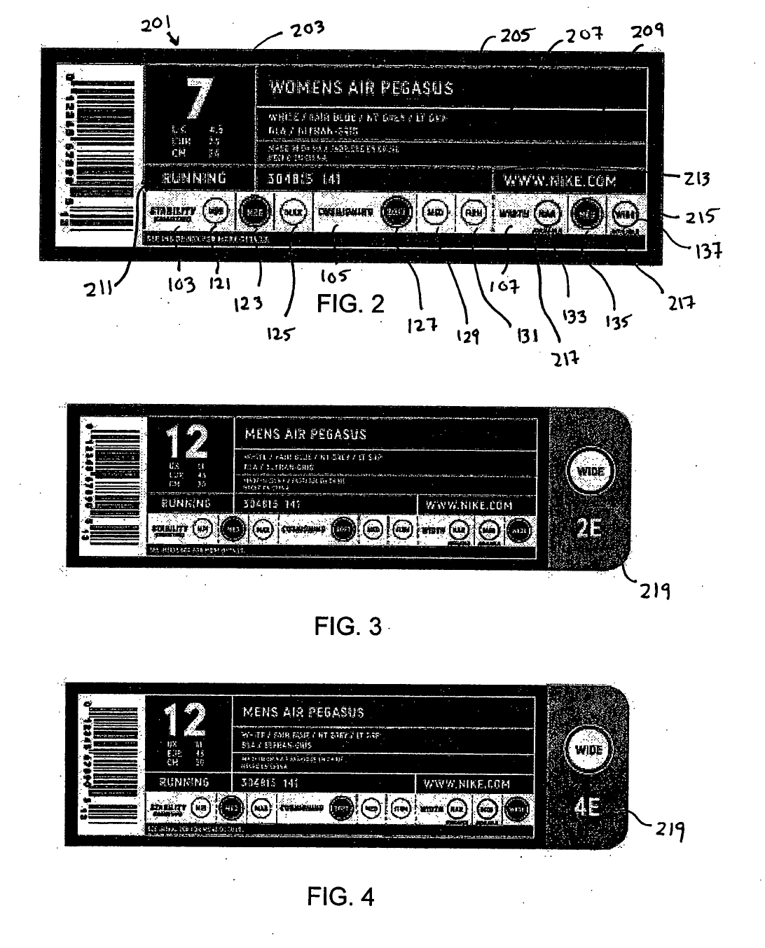

Turning now to FIG. 2, this figure illustrates a display area 201 that may be provided on the packaging for a pair of athletic shoes. The display area 201 may provide, for example, a size listing 203, a model name listing 205, a style listing 207, a country of origin listing 209, a purpose category listing 211 (listing the intended purpose for the packaged footwear), and a model number listing 213. With various embodiments of the invention, the display area will also include a performance characteristics listing 215.

As seen in this figure, the performance characteristics listing 215 displays the same available performance categories 103-105 as the index 101, together with each available performance characteristic 121-137 associated with the performance categories 103-105. With the performance characteristics listing 215, however, the specific performance characteristics for the packaged footwear will be displayed differently (or otherwise distinguished) from the other available performance characteristics. For example, in FIG. 2, the packaged footwear possesses a medium stability performance characteristic, a soft cushioning characteristic, and a medium width performance characteristic. Accordingly, the appearance of the listing of the medium stability performance characteristic 123 is different from the listings of the minimum stability performance characteristic 121 and the maximum stability performance characteristic 125. Similarly, the appearance of the listing of the soft cushioning performance characteristic 127 is different from the listings of the medium cushioning performance characteristic 129 and the firm cushioning performance characteristic 131, while the appearance of the listing of the medium width performance characteristic 135 is different from the listings of the narrow width performance characteristic 133 and the wide width performance characteristic 137.

In the illustrated embodiment, for example, the circle corresponding to the medium stability performance characteristic 123 is colored, whereas the circles corresponding to the minimum stability performance characteristic 121 and the maximum stability performance characteristic 125 are not. Of course, alternate or additional techniques for distinguishing the relevant performance characteristics may be used. Further, with some embodiments of the invention, performance characteristics that are not possessed by the packaged footwear may be omitted from the performance characteristics listing 215 altogether.

In addition to listing the performance characteristics that may generally be available from a manufacturer or other retailer of the packaged footwear, the performance characteristics listing 215 may also indicate the performance characteristics that are available for that particular model of footwear. For example, a typical footwear manufacturer will manufacture athletic footwear in a variety of shoe models. While some of these models will be available with narrow and wide width performance characteristics 133 and 137, the manufacturer may not provide these width performance characteristics for every model of shoe it makes. Accordingly, the footwear manufacturer may include the narrow and wide width performance characteristics 133 and 137 on the index 101 as available performance characteristics, but a consumer may not be able to determine which particular shoe models offer one or both of these performance characteristics.

Accordingly, the display of the performance characteristics 121-137 in the performance characteristics listing 215 may also include information indicating whether one or more specific performance characteristics are available for that model of footwear. For example, as shown in FIG. 2, the display of the narrow and wide width performance characteristics 133 and 137 in the performance characteristics listing 215 may also include text 217, such as the word “available,” to indicate whether those specific performance characteristics are available for that model of footwear. Of course, other indicators, such as icons or color indicators, may alternately or additionally be used to show the availability of a performance characteristic for a particular model of footwear.

With various examples of the invention, the display area 201 may include additional information regarding one or more of the performance characteristics possessed by the packaged footwear. For example, as shown in FIGS. 3 and 4, the display area 201 may include a performance characteristics detail listing 219 showing more detailed information regarding one or more of the performance characteristics possessed by the packaged footwear. In these illustrated examples, the performance characteristics detail listing 219 shows a particular width size for the wide width performance characteristic possessed by the packaged footwear. Of course, the performance characteristics detail listing 219 may display alternate or additional detailed information regarding one or more of the relevant performance characteristics.

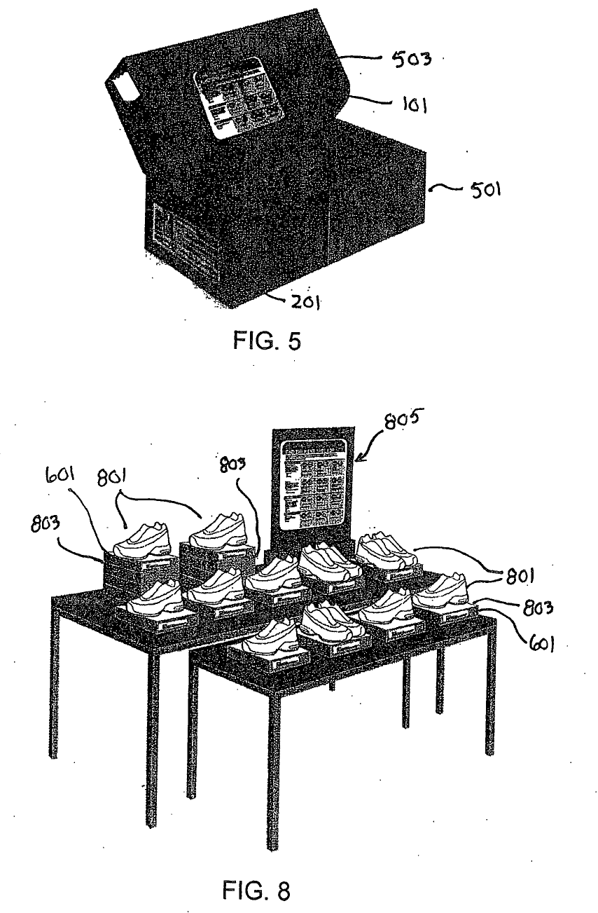

FIG. 5 illustrates how both the display area 201 and the index 101 may be used to market and purvey footwear. As shown in this figure, the packaging 501 for a pair of athletic footwear including the display area 201. Thus, a consumer can readily identify the performance characteristics for the packaged footwear from the outside of the package 501 itself. The package 501 may also include a copy of the index 101. For example, in the illustrated embodiment, the index 101 is printed or pasted to the inside of the lid 503 of the package 501. Thus, if a consumer desires more information regarding one or more of the performance characteristics for the packaged footwear, the consumer can simply refer to the index 101 on the inside of the lid 503 for the additional information.

It should be appreciated that the index 101 and the performance characteristics listing 215 on the display area 201 provide two different tiers of information regarding performance characteristics associated with the packaged footwear. The first tier of information, represented by the performance characteristics listing 215, informs a consumer as to the specific performance characteristics possessed by the packaged footwear. With various embodiments of the invention, the performance characteristics listing 215 may also inform the consumer as to the other performance characteristics that are generally available in the footwear provided by the footwear manufacturer or retailer, and/or other performance characteristics that are available for that specific model of footwear. The second tier of information, represented by the index 101, informs the consumer as to the different performance characteristics that are generally available in the footwear provided by the footwear manufacturer or retailer. In addition, the index 101 educates the consumer as to suitability of the different performance characteristics for various uses, consumer qualities or activities.

Tags And Inserts

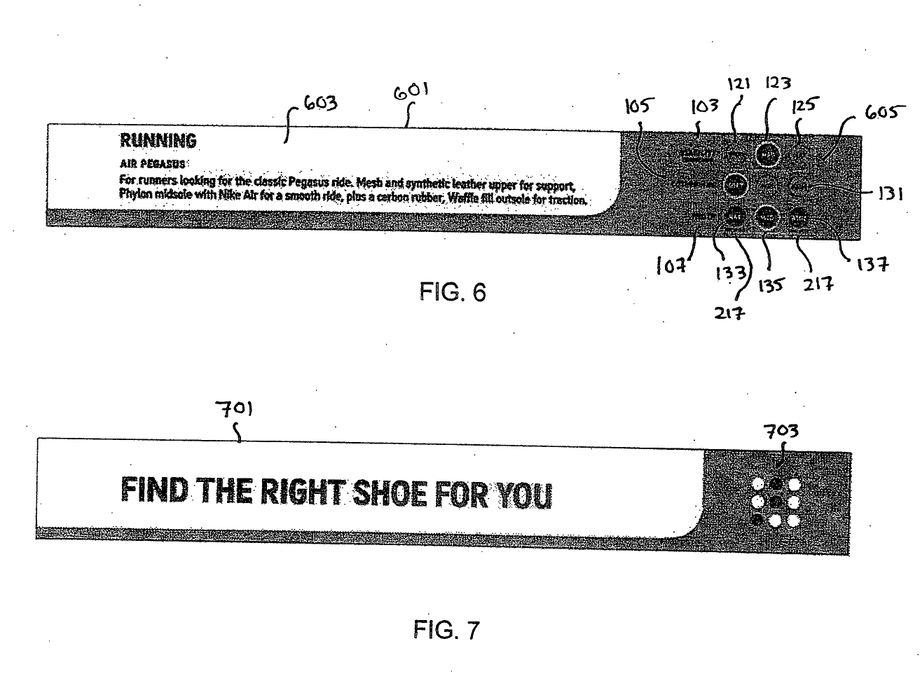

FIG. 6 illustrates a tag 601 that may be used according to various embodiments of the invention. The tag 601 includes a model description area 603, which provides the model name and a brief description of the associated footwear. Like the performance characteristics listing 215, the tag 601 also includes a performance characteristics listing 605 that displays each of the performance categories 103-107, and each of the performance characteristics 121-137 associated with the performance categories 103-17. Because the tag 601 will correspond to a particular pair athletic of shoes, the performance characteristics listing 605 displays the particular the specific performance characteristics for that footwear differently from the other available performance characteristics.

With the illustrated example, the associated footwear possesses a medium stability performance characteristic, a soft cushioning characteristic, and a medium width performance characteristic. The circle corresponding to the medium stability performance characteristic 123 thus is colored, whereas the circles corresponding to the minimum stability performance characteristic 121 and the maximum stability performance characteristic 125 are not. Similarly, the circle corresponding to the soft cushioning performance characteristic 127 and the circle corresponding to the medium width performance characteristic 135 are colored, while the circles corresponding to the medium and firm cushioning performance characteristics 129 and 131 and the circles corresponding to the narrow and wide width performance characteristics 133 and 137 are not.

Of course, alternate or additional techniques for distinguishing the performance characteristics of the particular associated footwear may be used. Again, with some embodiments of the invention, performance characteristics that are not possessed by the packaged footwear may be omitted from the tag 601 altogether. Also, as shown in this figure, the tag 601 may indicate performance characteristics that are not possessed by the associated pair of shoes but which are still available for that particular model of footwear.

FIG. 7 illustrates another tag 701 according to other embodiments of the invention. As shown in this figure, the tag 701 does not expressly name the performance characteristics of its associated footwear. Instead, the tag 701 displays a matrix 703 of items corresponding to the matrix in which the performance characteristics are arranged in the index 101. By distinguishing specific items having the same corresponding location in the matrix of index 101 as a desired performance characteristic, the matrix 703 can inform the user as to the performance characteristics of the associated footwear. For example, the middle item in the first row of the matrix 703 is color differently from the items on either side. This position of this middle item corresponds to the position of the listing of medium stability performance characteristic 123 in the index 101. Thus, a consumer can ascertain that the footwear associated with the tag 701 possesses the medium stability performance characteristic 123. Similarly, a consumer can determine that the associated footwear has the medium cushioning performance characteristic 129 and the narrow width performance characteristic 133.

FIG. 8 illustrates how the tags 601 and 701 may be used to market or purvey athletic footwear. As shown in this figure, various examples of footwear 801 are placed on pedestals 803. The front of each pedestal 803 then displays a tag 601 showing the performance characteristics of the shoe supported by the pedestal. Further, a placard 805 displaying the index 101 is placed near the footwear 801. Accordingly, a consumer may use the placard 805 to determine the performance characteristics that the consumer desires, and then use the tags 601 to identify a particular model or pair of footwear with those performance characteristics.

It should be noted that still other educational tools, in addition to the tag 701, may employ the matrix arrangement of the performance characteristics 121-137 as shown in the index 101 to educate a consumer. For example, the footwear manufacturer or other retailer may provide a consumer with a card having chads corresponding to each performance characteristic. A consumer can then punch out the chads corresponding to the desired performance characteristics, creating a pattern of punched-out holes. The consumer can then compare that pattern with, e.g., the marked performance characteristics shown in the performance characteristics listing 215 on the package 501.

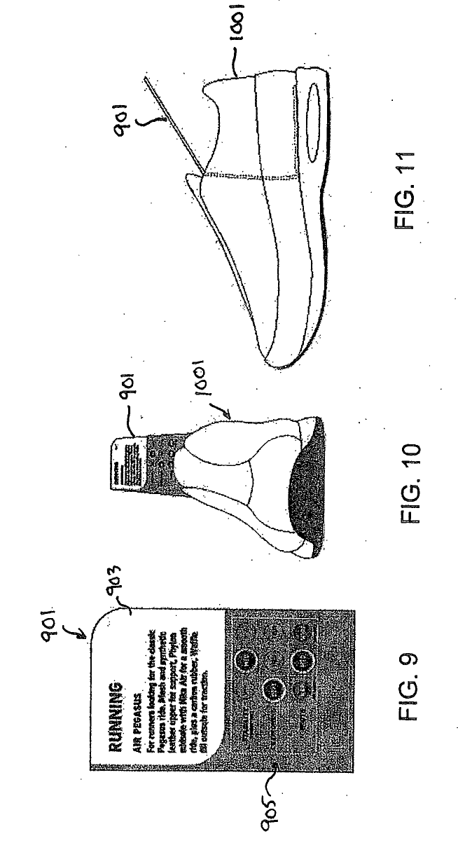

FIG. 9 illustrates an insert 901 that may be inserted into an athletic shoe. The insert 901 also includes a model description area 903, which provides the model name and a brief description of the associated footwear, and a performance characteristics listing 905 that displays each of the performance categories 103-107, and each of the performance characteristics 121-137 associated with the performance categories 103-107. Because the insert 901 will correspond to a particular pair athletic of shoes, the performance characteristics listing 905 displays the particular the specific performance characteristics for that footwear differently from the other available performance characteristics. FIGS. 10 and 11 then illustrate how the insert 901 may be inserted into a shoe 1001.

It should be appreciated that the tag 601 and the insert 901 provide additional tiers of information relating to the athletic footwear provided by the manufacturer or retailer. While the tag 601 and the insert 901 may contain the same information as the display area 201 on the packaging 501, the tag 601 and insert 901 are provided to a consumer at different times or locations in the procurement process. As previously noted, the tag 601 may be displayed on a pedestal with its associated footwear, which a consumer will view before viewing the packaging 501. The tag 601 may also be placed in or attached to its associated footwear, like the insert 901. Again, a consumer may thus view the tag 601 or insert 901 before viewing the packaging 501. The tag 701 provides yet another tier of information, as it is provided to the consumer at a different time and location than the display area 201, and moreover displays even more simplified information.

Display Placard

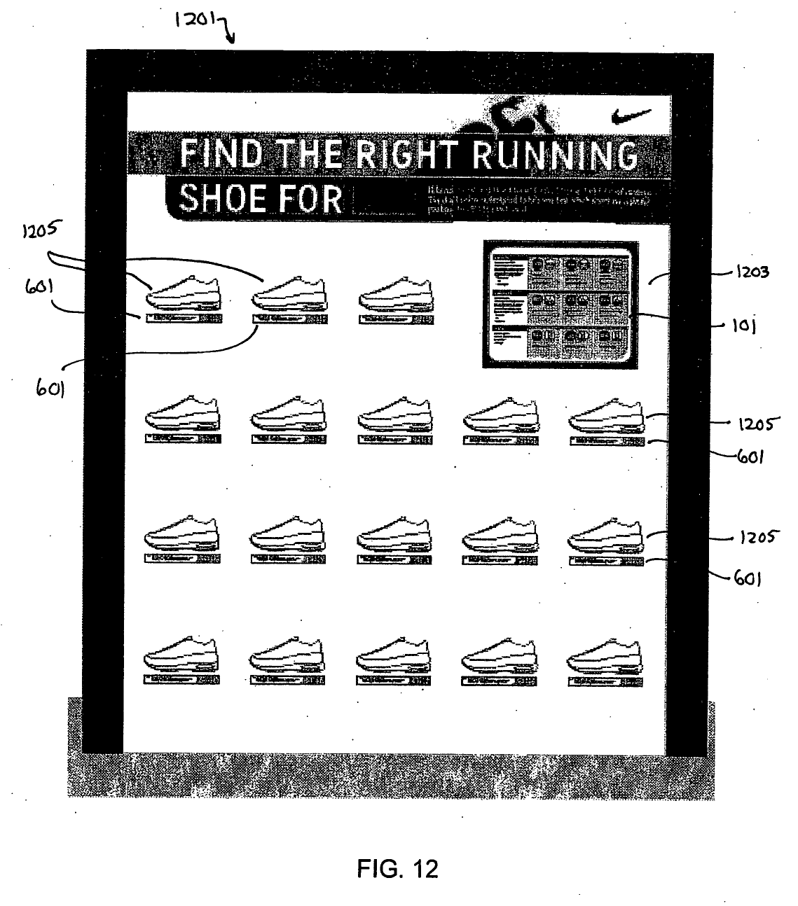

FIG. 12 illustrates a display placard 1201 providing still another tier of performance characteristic information for a consumer. As shown in this figure, the placard 1201 includes an index display area 1203 displaying the index 101. It also displays a variety of different shoe models 1205. An associated tag 601 then is printed or pasted under each shoe model. Thus, like the live sales display show in FIG. 8, a consumer may use the index 101 shown in the index display area 1203 to determine the performance characteristics that the consumer desires. The consumer can then use the displayed tags 601 and the illustration of the different shoe models 1205 to identify a particular model or pair of footwear with those desired performance characteristics.

Of course, still other tools may be used to educate a consumer regarding the various tiers of information. For example, the footwear manufacturer or other retailer may provide consumers with a pin wheel that can be rotated to display information regarding the available performance characteristics.

Use Of Quantitative Values For The Performance Characteristics

As previously noted, according to various embodiments of the invention, the performance characteristics are not abstract or anecdotal characterizations. Instead, one or more of the performance characteristics may correspond to a specific quantitative value or to a specific range of quantitative values. For example, with some embodiments of the invention described above, the soft cushioning performance characteristic may correspond to a cushioning of 10-15 p.s.i. (pounds per square inch). The medium cushioning performance characteristic may then correspond to a cushioning of 15-20 p.s.i., while the firm cushioning performance characteristic may correspond to a cushioning of 20 p.s.i. or greater.

By providing performance characteristics that correspond to specific quantitative values, an athletic apparel manufacturer can allow a consumer to consistently select the desired athletic apparel. For example, a consumer may purchase athletic apparel, such as model of athletic footwear, having a particular combination of performance characteristics. If the consumer is satisfied with that model of footwear, the consumer can safely purchase another model of footwear having the same performance characteristics. That is, because the performance characteristics for both models of footwear correspond to specific quantitative values, the consumer can be assured that the second model of footwear will actually perform in the same manner as the first model of footwear.

With various embodiments of the invention, yet another tier of information may be provided by the athletic apparel manufacturer or other retailer that educates the consumer as to the corresponding quantitative value. Thus, in the examples of the invention relating to footwear discussed above, the footwear manufacturer or other footwear retailer may provide a placard, brochure, Internet Web site or other media device describing the correspondence between the performance characteristics and their corresponding quantitative values.

Conclusion

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A package for identifying footwear, comprising:
a container for the footwear, and
a display area on the container displaying a plurality of performance characteristic values for the footwear.

2. The package recited in claim 1, wherein the performance characteristic values include a value for at least one characteristic selected from the group of a stability characteristic, a cushioning characteristic, and a fit characteristic.

3. The package recited in claim 1, wherein the display area on the package displays three or more performance characteristic values for the footwear.

4. The package recited in claim 1, further comprising:
a second display area displaying model identification information for the footwear, and
wherein the first display area further displays at least one alternate performance characteristic value corresponding to the model identification information.

5. The package recited in claim 1, wherein the first display area
displays a plurality of possible performance characteristic values; and
displays indicators designating the plurality of performance characteristic values for the footwear from among the plurality of possible performance characteristic values.

6. The package recited in claim 5, wherein the plurality of possible performance characteristic values are arranged in a matrix.

7. The package recited in claim 5, further comprising:
a second display area displaying model identification information for the footwear, and
second indicators in the first display designating at least one alternate performance characteristic value corresponding to the model identification information from among the plurality of possible performance characteristic values.

8. A method of purveying footwear, comprising:
providing packaging for footwear that displays values for a plurality of performance characteristics associated with the footwear; and
providing information regarding the performance characteristics at a point of sale of the footwear.

9. A method of providing information regarding apparel, comprising:
providing a first tier of information with an article of apparel, such that the first tier of information describes performance characteristic values for the article of apparel; and
separately providing a second tier of information that quantitatively defines the performance characteristics for the article of apparel.

10. The method recited in claim 9, wherein:
the article of apparel is footwear; and
the performance characteristics values include a value for at least one characteristic selected from the group of a stability characteristic, a cushioning characteristic, and a fit characteristic.

11. A method assisting a consumer in purchasing an article of apparel, comprising:
providing a consumer with a card describing a matrix of possible performance characteristic values for an article of apparel, a portion of the card being removable for each value in the matrix such that a user can remove portions of the card corresponding to desired performance characteristic values for an article of apparel; and
packaging articles of apparel with a display showing performance characteristic values for each article of apparel arranged in the matrix, such that a user can compare removed portions of the card with the displayed performance characteristic values for each article of apparel to identify if each article of apparel includes the desired performance characteristics values.

12. A method of purveying footwear, comprising:
obtaining a plurality of different types of footwear;
analyzing each type of footwear to determine a plurality of performance characteristic values for each type of footwear according to a single quantitative definition of the performance characteristics; and
selling the plurality of different types of footwear with packaging that displays the determined plurality of performance characteristic values for each type of footwear.

13. A method of providing information regarding apparel, comprising:
providing a first tier of information with an article of apparel, such that the first tier of information describes performance characteristic values for the article of apparel; and
separately providing a second tier of information that defines the performance characteristics for the article of apparel based upon use of the article of apparel by a consumer.

14. A method of purveying articles of apparel, comprising:
displaying model identification information for an article of apparel,
displaying first performance characteristic values associated with the article of apparel; and
displaying second performance characteristics values associated with the model identification information.
